(19) United States
(12) Patent Application Publication
(10) Pub. No.: US 2016/0034192 A1
(43) Pub. Date: Feb. 4, 2016

(54) DATA STORAGE DEVICE AND OPERATION METHOD THEREOF

(71) Applicant: SK hynix Inc., Gyeonggi-do (KR)

(72) Inventor: Jong-Min LEE, Gyeonggi-do (KR)

(21) Appl. No.: 14/569,421

(22) Filed: Dec. 12, 2014

(30) Foreign Application Priority Data
Jul. 31, 2014 (KR) 10-2014-0098486

(51) Int. Cl. G06F 3/06

(52) U.S. Cl. CPC G06F 3/0604; G06F 3/0659; G06F 3/0673

(57) ABSTRACT

A data storage device includes a memory including a plurality of memory blocks each of which includes a plurality of pages to write a data transmitted from a host therein, and a controller suitable for storing page information on the pages of each of the memory blocks, wherein the page information is updated based on a data update performed in a page where the data is written among the pages of each of the memory blocks.

### CROSS-REFERENCE TO RELATED APPLICATIONS

The present application claims priority of Korean Patent Application No. 10-2014-0098486, filed on Jul. 31, 2014, which is incorporated herein by reference in its entirety.

### BACKGROUND

1. Field

Exemplary embodiments of the present invention relate to a data storage device and, more particularly, to a device for storing page information on a plurality of pages of a memory where data are written, and a method for operating the same.

2. Description of the Related Art

The paradigm of the computer environment is shifting to ubiquitous computing systems where people can use computers any time anywhere. This increases the usage of portable electronic devices, such as mobile phones, digital cameras, laptop computers and the like. These portable electronic devices generally use data storage devices employing memories. The data storage devices are used as main memory units or secondary memory units of the portable electronic devices.

The data storage devices using memories are excellent in terms of stability and durability because they do not have moving parts. Also, data storage devices using memories have advantages of operating at fast data access rates and with low power consumption. Non-limiting examples of data storage devices having the above-described advantages include Universal Serial Bus (USB) memory devices, memory cards with diverse interfaces, Solid-State Drives (SSD) and so forth.

### SUMMARY

An embodiment of the present invention is directed to a data storage device capable of storing page information on a plurality of pages so that data may be written on the pages in a memory by using as many pages as possible, and a method for operating the data storage device.

In accordance with an embodiment of the present invention, a data storage device includes a memory including a plurality of memory blocks each of which includes a plurality of pages to write data transmitted from a host therein, and a controller suitable for storing page information on the pages of each of the memory blocks, wherein the page information is updated based on a data update performed in a page where the data is written among the pages of each of the memory blocks.

In accordance with another embodiment of the present invention, a method for operating a data storage device includes checking a plurality of pages included in each memory block of a memory, writing data transmitted from a host in the pages of each of the memory blocks, and storing page information on the pages of each of the memory blocks, wherein the page information is updated based on a data update that is performed in a page where the data is written among the pages of each of the memory blocks.

### BRIEF DESCRIPTION OF THE DRAWINGS

FIG. 1 is a block view illustrating a data processing system including a data storage device in accordance with an embodiment of the present invention.

FIG. 2 illustrates an example of the data storage device in accordance with an embodiment of the present invention.

FIG. 3 illustrates an example of a data write operation and a page information storing operation that are performed in the data storage device in accordance with an embodiment of the present invention.

FIG. 4 is a flowchart describing a process of storing page information in the data storage device in accordance with an embodiment of the present invention.

### DETAILED DESCRIPTION

Exemplary embodiments of the present invention will be described below in more detail with reference to the accompanying drawings. The present invention may however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and in some instances, proportions may have been exaggerated in order to clearly illustrate features of the embodiments. It is also noted that in this specification, “connected/coupled” refers to one component not only directly coupling another component but also indirectly coupling another component through an intermediate component. In addition, a singular form may include a plural form as long as it is not specifically mentioned in a sentence.

Hereafter, an embodiment of the present invention is described in detail with reference to the accompanying drawings.

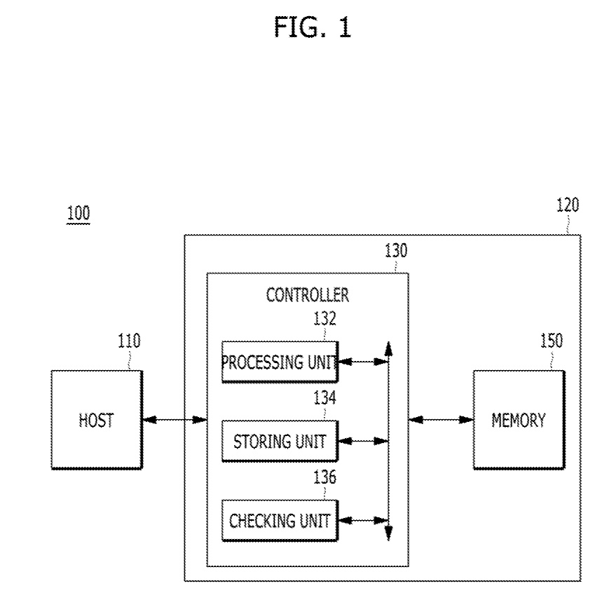

FIG. 1 is a block view illustrating a data processing system including a data storage device in accordance with an embodiment of the present invention.

Referring to FIG. 1, the data processing system 100 includes a host 110 and a data storage device 120.

Non-limiting examples of the host 110 include portable electronic devices, such as mobile phones, MP3 players, laptop computers, etc., and electronic devices such as desktop computers, game players, TV, projectors and the like.

Also, the data storage device 120 operates in response to a request from the host 110. The data storage device 120 stores data that are accessed by the host 110. In other words, the data storage device 120 may be used as a main memory unit or a secondary memory unit of the host 110. The data storage device 120 may be realized as one among diverse kinds of storage devices based on host interface protocol for connection with the host 110. For example, the data storage device 120 may be one among a Solid-State Drive (SSD), a Multi-Media Card (MMC), an embedded MMC (eMMC), a Reduced-Size MMC (RS-MMC), a micro-MMC, a Secure Digital (SD) card, a mini-SD card, a micro-SD card, a Universal Storage Bus (USB) storage device, a Universal Flash Storage (UFS) device, a Compact Flash (CF) card, a smart media card, a memory stick and so forth.

Also, the data storage device 120 includes a memory 150 for storing data that are accessed by the host 110 and a controller 130 for controlling the storing of data into the memory 150.

The memory 150 may retain the stored data even when no power is supplied. Particularly, the memory 150 stores data provided by the host 110 through a write operation, and transmits the stored data to the host 110 through a read operation.

The controller 130 controls the memory 150 in response to a request from the host 110. For example, the controller 130 provides the host 110 with data that are read from the memory 150, and stores the data inputted from the host 110 in the memory 150. To this end, the controller 130 controls such operations of the memory 150 as a read operation, a program operation, and an erase operation.

Herein, the controller 130 includes a processing unit 132, a storing unit 134, and a checking unit 136.

The processing unit 132 controls the general operations of the data storage device 120, and controls the write or read operation performed on the memory 150 in response to a write or read request transmitted from the host 110. The processing unit 132 drives firmware, called a Flash Transition Layer (FTL), to control the operations of the data storage device 120.

The storing unit 134 stores the FTL that is driven by the processing unit 132. The storing unit 134 also stores various data that are used for the processing unit 132 to control the data storage device 120. Particularly, the storing unit 134 stores information on the data that are stored in the memory 150. For example, when data are written in the memory 150 upon the receipt of a write request transmitted from the host 110, the storing unit 134 stores page information on a plurality of pages included in each memory block of the memory 150.

To be specific, the memory 150 includes a plurality of memory blocks, and each of the memory blocks includes a plurality of pages. When data are written in the pages upon the receipt of the write request transmitted from the host 110, page information on pages available for the data to be written, which is referred to as ‘valid pages’, hereafter, is stored in the storing unit 134. The storing unit 134 stores page information on the pages, particularly, page information on the valid pages, so that the data transmitted from the host 110 may be written on as many pages of the memory blocks as possible. The page information includes information for indexing the pages, such as information on the number and index of pages, and more particularly the number and index of valid pages.

Also, the checking unit 136 checks the pages when data are to be written on the pages upon receipt of a write request transmitted from the host 110. For example, the checking unit 136 checks the number of the valid pages in each memory block, checks the pages where data are written already and checks the data update on pages and the pages with updated data (or invalid pages). The page information stored in the storing unit 134 is updated based on the check results of the checking unit 136.

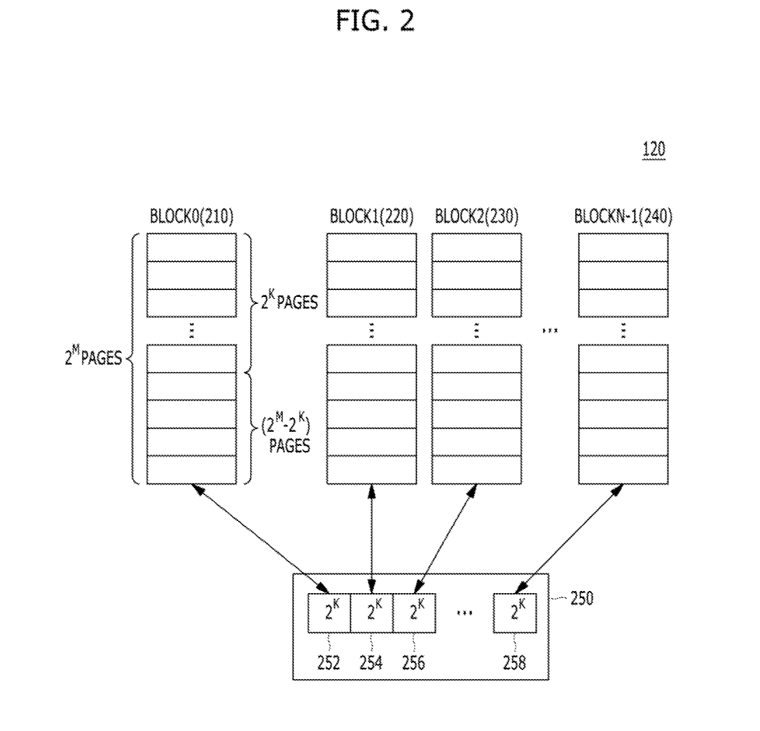

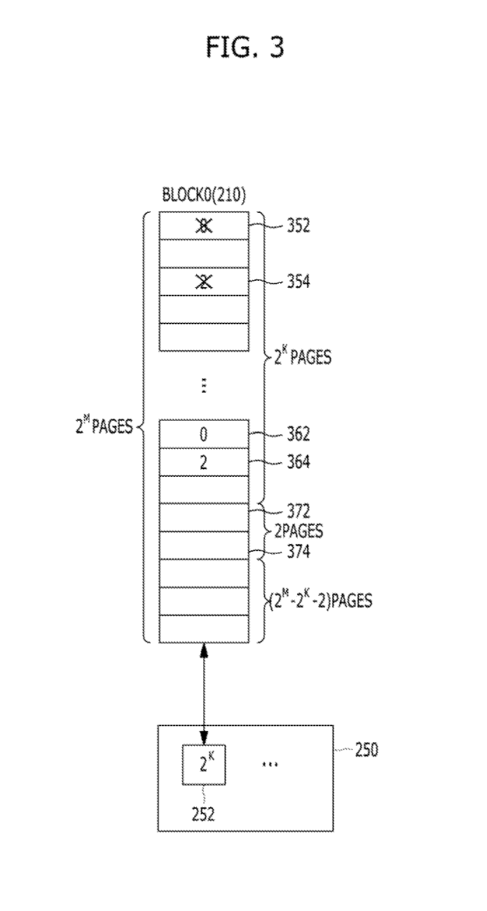

Hereafter, a data write operation and a page information storing operation according to the data write operation in the data storage device in accordance with the embodiment of the present invention are described in detail with reference to FIGS. 2 and 3.

FIG. 2 illustrates an example of the data storage device shown in FIG. 1 in accordance with an embodiment of the present invention. FIG. 3 illustrates an example of the data write operation and the page information storing operation that are performed in the data storage device shown in FIG. 1 in accordance with an embodiment of the present invention.

Referring to FIG. 2, the data storage device 120 includes a plurality of memory blocks, which includes a first memory block BLOCK0 (210), a second memory block BLOCK1 (220), a third memory block BLOCK2 (230), an Nth memory block BLOCKN−1 (240). Each of the memory blocks 210, 220, 230 and 240 includes a plurality of pages, for example, 2^{M} pages. The memory 150 shown in FIG. 1 may include the memory blocks 210 to 240.

The data storage device 120 further includes a storing unit 250. The storing unit 250 may correspond to the storing unit 134 shown in FIG. 1. The storing unit 250 includes a plurality of storing regions for storing page information on a plurality of pages included in the memory blocks 210, 220, 230 and 240, in other words, page information on the 2^{M} pages. The storing regions include a first storing region 252, a second storing region 254, a third storing region 256 and an Nth storing region 258. The storing regions 252, 254, 256 and 258 store page information on the corresponding 2^{M} pages of the memory blocks 210, 220, 230 and 240, respectively.

In other words, the first storing region 252 stores page information on the 2^{M} pages of the first memory block BLOCK0 (210), and the second storing region 254 stores page information on the 2^{M} pages of the second memory block BLOCK1 (220). The third storing region 256 stores page information on the 2^{M} pages of the third memory block BLOCK2 (230), and the Nth storing region 258 stores page information on the 2^{M} pages of the Nth memory block BLOCKN−1 (240). Also, when each of the storing regions 252, 254, 256 and 258 is assigned with K bits, each of the storing regions 252, 254, 255 and 258 stores page information on 2^{K} pages among the 2^{M} pages of the corresponding memory block 210, 220, 230 or 240.

To store page information on all the pages of the memory blocks 210, 220, 230 and 240, in other words, to store page information on 2^{M} pages of each memory block 210, 220, 230 or 240, each of the storing regions 252, 254, 256 and 258 have to be assigned with M bits (M≧K), but the number of bits that may be assigned to the storing unit 250 is limited. In other words, since the number of bits that may be assigned to each of the storing regions 252, 254, 256 and 258 is K, each of the storing regions 252, 254, 256 and 258 stores page information on 2^{K} pages among the 2^{M} pages of the corresponding block 210, 220, 230 or 240. Hereafter, for a simple description, a data write operation and a page information storing operation performed in the first memory block BLOCK0 (210) are exemplarily described with reference to FIG. 3.

Referring to FIG. 3, as described above, the first memory block BLOCK0 (210) includes 2^{M} pages. In this case, the first storing region 252 stores page information on 2^{K} pages among the 2^{M} pages of the first memory block BLOCK0 (210). In short, the first storing region 252 includes information representing that the 2^{K} pages among the 2^{M} pages of the first memory block BLOCK0 (210) are valid pages. The information representing that the 2^{K} pages among the 2^{M} pages of the first memory block BLOCK0 (210) are valid pages includes valid page number information or valid page index information.

For the first storing region 252 to store the page information on all the pages of the first memory block BLOCK0 (210), which are the 2^{M} pages, the first storing region 252 has to be assigned with M bits (M≧K), but the number of bits that may be assigned to the first storing region 252 is limited. For this reason, the first storing region 252 is capable of storing the page information on the 2^{K} pages and the first storing region 252 is not capable of storing the other pages, which are 2^{M}-2^{K} pages. In other words, when data are written in the first memory block BLOCK0 (210) upon receipt of a request from a host 110, the first storing region 252 provides, not the page information on the pages of the first memory block BLOCK0 (210), but the information representing that the 2^{K} pages among the 2^{M} pages of the first memory block BLOCK0 (210) are valid pages, which is the valid page number information or the valid page index information of the 2^{K} pages.

In this case, when data are being written in the first memory block BLOCK0 (210) upon a request for a write operation from the host 110 while the data written in a page 352 and a page 354 of the first memory block BLOCK0 (210) are updated, the number of times that data are updated becomes ‘2’. Also, the page 352 and the page 354 of the first memory block BLOCK0 (210) are set as invalid pages due to the data update operation. Also, the information on the valid page of the first memory block BLOCK0 (210) is set following the data update operation and the setup of the invalid pages.

To be specific, when data having logical page information (e.g., logical page number or logical page index) written in the page 352 of the first memory block BLOCK0 (210), which is referred to as ‘a data 0’ having a logical page number 0, is written in a first page 362 of the first memory block BLOCK0 (210), the data 0 is updated and thus the page 352 of the first memory block BLOCK0 (210) where the data 0 is previously written becomes an invalid page. Also, when data having a logical page number 2, which is referred to as ‘a data 2’, written in the page 354 of the first memory block BLOCK0 (210) is written in a second page 364 of the first memory block BLOCK0 (210), the data 2 is updated and thus the page 354 of the first memory block BLOCK0 (210) where the data 2 is previously written becomes an invalid page.

As described above, when data is written in the first memory block BLOCK0 (210), the checking unit 136 of the controller 130 checks out the information on the 2^{M} pages included in the first memory block BLOCK0 (210). In short, the checking unit 136 of the controller 130 checks out the information on the page (which is the invalid page) updated with data due to the data update operation performed on the first memory block BLOCK0 (210) and the information on the valid pages. As a result, the page information on the valid pages in the first memory block BLOCK0 (210) is stored in the first storing region 252 of the storing unit 250 as the page information on the 2^{M} pages of the first memory block BLOCK0 (210).

As described above, when data are written in the first memory block BLOCK0 (210), the data 0 and the data 2 are updated, and the number of times that the data are updated is 2 and the number of invalid pages becomes 2. Herein, the first storing region 252 that stores the information on the valid pages in the first memory block BLOCK0 (210) stores information for indexing 2^{K} pages, which is information representing that the 2^{K} pages are valid pages or index information of 2^{K} pages. Since the number of times that the data are updated is 2 and the number of the invalid pages is 2, the first storing region 252 excludes information on the two invalid pages 352 and 354 and stores page information on two valid pages 372 and 374.

In short, the first storing region 252 additionally stores two valid pages 372 and 374 instead of the two invalid pages 352 and 354 occurring due to the pages 362 and 364 updated with data Therefore, the page information for indexing the 2^{K} pages further includes the page information on the two valid pages 372 and 374, instead of the page information on the invalid pages 352 and 354, and thus includes the information representing that the 2^{K} pages are valid pages or index information of the 2^{K} pages. Therefore, the first storing region 252 does not store the page information on the 2^{M}-2^{K}-2 pages. Since the page information on the two pages 372 and 374 is additionally stored in the first storing region 252 as the page information on the 2^{M} pages in the first memory block BLOCK0 (210), the data storage device in accordance with the embodiment of the present invention may maximally use the 2^{M} pages in the first memory block BLOCK0 (210) to write the data transmitted from the host 110 in the 2^{M} pages. Hereafter, a process of storing page information in the data storage device in accordance with the embodiment of the present invention is described in detail.

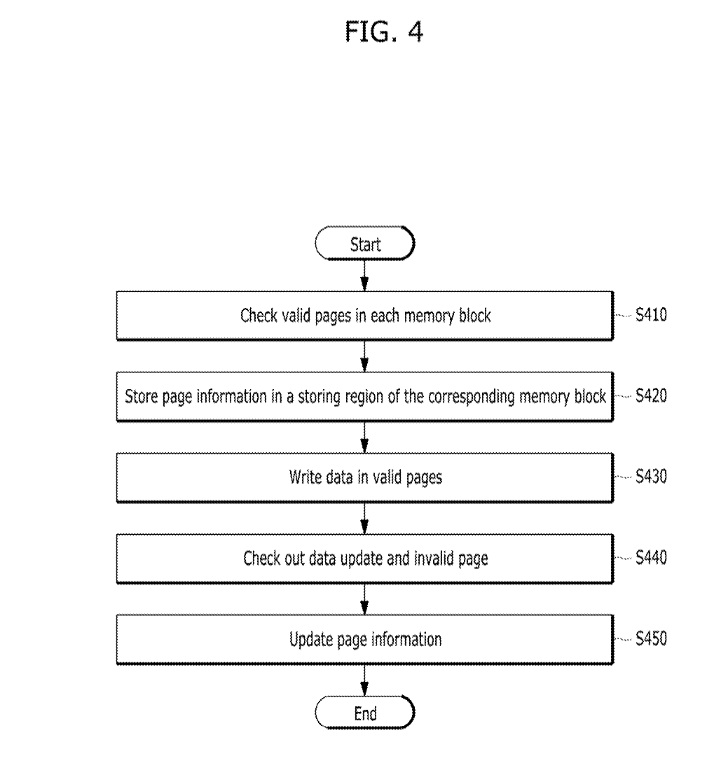

FIG. 4 is a flowchart describing a process of storing page information in the data storage device in accordance with the embodiment of the present invention.

Referring to FIG. 4, valid pages are checked out among a plurality of pages in each memory block of the data storage device, in step S410.

In step S420, page information on the pages of each memory block is stored in a storing region of the corresponding memory block based on the valid page checking result of each memory block. Herein, the page information includes index information for indexing the pages, such as page number information or page index information. For example, the page information includes valid page number information or valid page index information for indexing valid pages.

In step S430 data transmitted from a host is written in the pages, particularly, the valid pages, of each memory block based on the page information stored in the storing region. In step S440, it is checked whether data is updated through the write operation and whether there is an invalid page.

Subsequently, in step S450, the page information stored in the storing region is updated based on the data update and the invalid page checked in the step S440. Herein, the page information additionally includes information on the number of times that the data are updated or the page information on the invalid pages. Since the page information storing operation in the data storage device in accordance with the embodiment of the present invention is described in detail earlier with reference to FIGS. 2 and 3, further description on it is not provided herein.

According to the embodiments of the present invention, the data storage device and an operation method thereof may efficiently store page information on a plurality of pages so that data may be written on as many pages as possible in a memory.

While the present invention has been described with respect to the specific embodiments, it will be apparent to those skilled in the art that various changes and modifications may be made without departing from the spirit and scope of the invention as defined in the following claims.

What is claimed is:

1. A data storage device, comprising:
a memory including a plurality of memory blocks each of which includes a plurality of pages to write data transmitted from a host therein; and
a controller suitable for storing page information on the pages of each of the memory blocks,
wherein the page information is updated based on a data update performed in a page where the data is written among the pages of each of the memory blocks.

2. The data storage device of claim 1, further comprising:
a plurality of storing regions each assigned with a predetermined number of bits and suitable for storing page information on first pages, as many as the predetermined number of bits, among pages of a corresponding one of the memory blocks.

3. The data storage device of claim 2, wherein the page information is updated to further include page information on second pages, as many as the number of times that the data update is performed, among other pages than the first pages among the pages of the corresponding memory block.

4. The data storage device of claim 2, wherein the page information is updated to further include page information on second pages, as many as the number of invalid pages occurring due to the data update, among other pages than the first pages among the pages of the corresponding memory block.

5. The data storage device of claim 1, wherein the page information is information for indexing valid pages capable of writing the data therein among the pages of each of the memory blocks.

6. The data storage device of claim 5, wherein the information for indexing valid pages includes valid page number information or valid page index information.

7. A method hod for operating a data storage device, comprising:
checking a plurality of pages included in each of the memory blocks of a memory;
writing data transmitted from a host in the pages of each of the memory blocks; and
storing page information on the pages of each of the memory blocks,
wherein the page information is updated based on a data update that is performed in a page where the data is written among the pages of each of the memory blocks.

8. The method of claim 7, wherein the storing of the page information on the pages of each of the memory blocks includes:
storing page information on first pages, as many as a predetermined number of bits, among the pages of each of the memory blocks in storing regions of each of the memory blocks,
wherein the storing regions are assigned with the predetermined number of bits.

9. The method of claim 8, wherein the page information is updated to further include page information on second pages, as many as the number of times that the data update is performed, among other pages than the first pages among the pages of each of the memory blocks.

10. The method of claim 8, wherein the page information is updated to further include page information on second pages, as many as the number of invalid pages occurring due to the data update, among other pages than the first pages among the pages of each of the memory blocks.

11. The method of claim 7, wherein the page information is information for indexing valid pages capable of writing the data therein among the pages of each of the memory blocks.

12. The method of claim 11 wherein the information for indexing valid pages includes valid page number information or valid page index information.
